(19) United States
(12) Patent Application Publication
(10) Pub. No.: US 2022/0371500 A1
(43) Pub. Date: Nov. 24, 2022

(54) TRAILER

(71) Applicants: James J. Murrell, Amirillo, TX (US); Michael L. Logsdon, Chatham, IL (US)

(72) Inventors: James J. Murrell, Amirillo, TX (US); Michael L. Logsdon, Chatham, IL (US)

(21) Appl. No.: 17/751,602

(22) Filed: May 23, 2022

Related U.S. Application Data
(63) Continuation-in-part of application No. 63/191,875, filed on May 21, 2021.

(51) Int. Cl. B60P 3/06; B62D 61/12; B60S 13/00

(52) U.S. Cl. CPC B60P 3/06; B62D 61/12; B60S 13/00

(57) ABSTRACT

A trailer for transporting a vehicle includes a longitudinal beam extending between a forward end from which the trailer is towed and a rearward end. The trailer includes a platform having a top extending between a back and a front of the platform. The top has a support for receiving a rearward wheel of the vehicle. The platform has a mount for releasably attaching the beam to the platform. The platform has an axle extending laterally below a bottom of the platform. The trailer includes a carriage assembly having frame. A top surface of the frame includes a rest for supporting a forward wheel of the vehicle. The carriage assembly includes a connector for selectively connecting the carriage assembly to the beam in front of the platform so the carriage assembly is moveable along the beam.

### CROSS-REFERENCE TO RELATED APPLICATIONS

The present application claims priority to U.S. Provisional Patent Application 63/191,875 filed May 21, 2021, which is hereby incorporated by reference in its entirety.

### BACKGROUND

The present disclosure relates to a trailer, and more particularly, to a selectively disassembleable trailer for transporting vehicles including off-road vehicles.

Off-road vehicle or All-Terrain Vehicle (ATV) enthusiasts frequently transport their vehicles to sites where the ATVs are used. In general, the vehicles are transported in a truck bed or on a trailer that is pulled by a tow vehicle. Loading smaller ATVs into truck beds can be difficult, and larger off-road vehicles are too large to be carried in conventional pickup truck beds. Accordingly, many enthusiasts prefer to transport their off-road vehicles on trailers. Many trailers for transporting vehicles are large and difficult to maneuver when disconnected from the tow vehicle. These trailers also take up space when stored, reducing storage space. Thus, there is a need for a trailer for hauling vehicles such as off-road vehicles that is more conveniently stored and maneuvered.

### SUMMARY

In one aspect, the present disclosure includes a trailer for transporting a vehicle having a forward wheel and a rearward wheel. The trailer comprises a longitudinal beam extending between a forward end from which the trailer is towed and a rearward end opposite the forward end. The trailer includes a platform having a left side, a right side opposite the left side, a back extending between the left side and the right side, a front opposite the back, a top extending between the back and the front and a bottom opposite the top. The top has a support for receiving the rearward wheel of the vehicle. The platform has a mount for releasably attaching the beam to the platform so the forward end of the beam extends forward from the front of the platform. The platform has an axle extending laterally below the bottom of the platform between a left wheel and a right wheel for supporting the platform and permitting the trailer to move forward and rearward. The trailer also comprises a carriage assembly including frame having a top surface and a bottom surface opposite the top surface. The top surface includes a rest for supporting the forward wheel of the vehicle. The carriage assembly includes a connector for selectively connecting the carriage assembly to the beam in front of the platform so the carriage assembly is moveable along the beam between a rearward position in which the carriage assembly is adjacent to the platform and a forward position in which the carriage assembly is spaced from the platform.

In another aspect, the disclosure includes a method of assembling a trailer for transporting a vehicle having a forward wheel and a rearward wheel. The method comprises positioning a longitudinal beam having a forward end and a rearward end opposite the forward end atop a carriage frame. The positioned carriage frame is connected to the beam so the frame is selectively moveable longitudinally along the beam. The rearward end of the beam is set on a mount on a platform having a left wheel and a right wheel for selectively moving the trailer forward and rearward. The rearward rearward end of the beam is pinned to the mount.

In yet another aspect, the disclosure includes a method of disassembling a trailer for storage. The method comprises disconnecting a connector pin from a connector connected to a carriage frame thereby allowing the connector to be separated from the carriage frame. The connected is removed from the carriage frame thereby allowing the beam to be separated from the carriage frame. The beam is separated from the carriage frame. The method further includes pulling a release pin from a platform attached to the beam thereby releasing the beam from the platform. The released beam is separated from the platform.

Other aspects of the present disclosure will be apparent in view of the following description and claims.

### BRIEF DESCRIPTION OF THE DRAWINGS

FIG. 1 is a top plan of a trailer showing a carrier assembly thereof in a rearward position;

FIG. 2 is a top plan of the trailer showing the carrier assembly in a forward position;

FIG. 3 is a top plan of a platform of the trailer when separated;

FIG. 4 is a bottom plan of the platform;

FIG. 5 is a top plan of the carrier assembly of the trailer when separated;

FIG. 6 is a bottom plan of the carrier assembly;

FIG. 7 is a cross section of the trailer taken through the plane of line 7-7 of FIG. 2;

FIG. 8 is a cross section of the platform and a ramp taken through the plane of line 8-8 of FIG. 2; and

FIG. 9 is an elevation of the platform and carriage assembly in a storage configuration.

Corresponding reference characters indicate corresponding parts throughout the drawings.

### DETAILED DESCRIPTION OF THE DRAWINGS

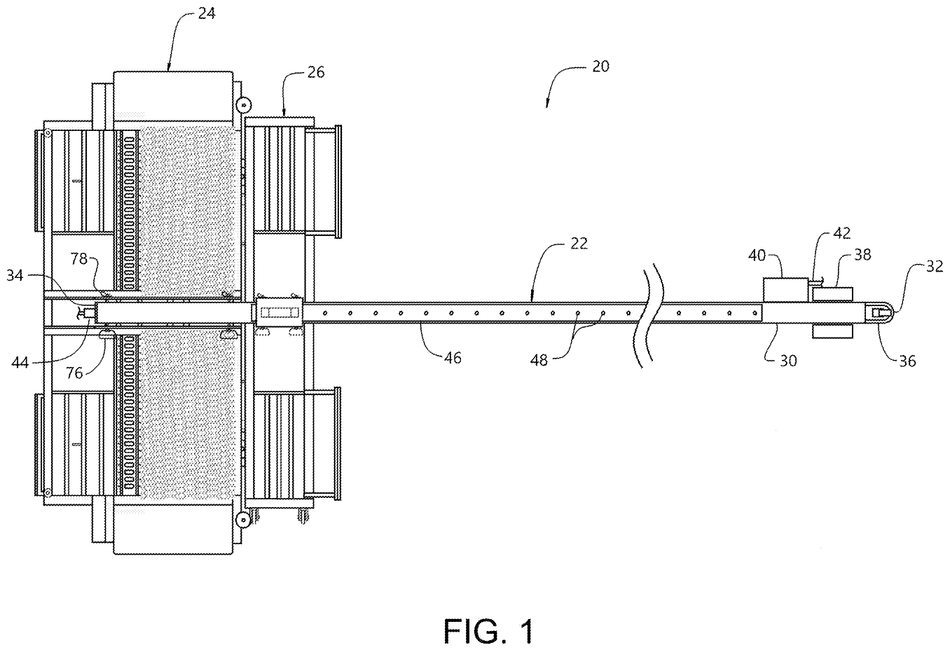

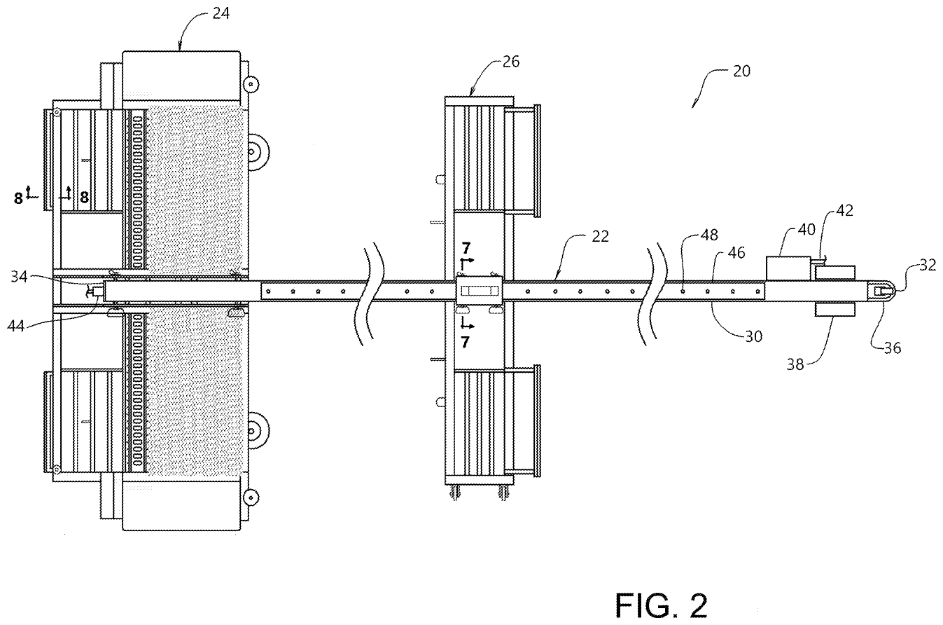

Referring now to the drawings and in particular to FIGS. 1 and 2, one example of a trailer is designated in its entirety by the reference number 20. The trailer 20 generally comprises a center beam (generally designated by 22), platform (generally designated by 24) mounted on the beam, and a carrier assembly (generally designated by 26) slidably attached to the beam. FIG. 1 illustrates the trailer 20 when the carrier assembly 26 is in a rearward position on the beam 22 in which the carrier assembly is adjacent to the platform 24. FIG. 2 illustrates the trailer 20 when the carrier assembly 26 is in a forward position on the beam 22 in which the carrier assembly is spaced from the platform 24. As will be appreciated, when a vehicle having front and rear wheels is carried by the trailer 20, the front wheels of the vehicle rest on the carrier assembly 26 and the rear wheels of the vehicle are supported by the platform 24. Accordingly, the carrier assembly 26 is in the forward position on the beam 22 when the trailer 20 carries the vehicle. As will be explained, the trailer frame 20 is selectively disassembleable such that the platform 24, carrier assembly 26, and beam 22 are separated and may be moved separately.

As further shown in FIGS. 1 and 2, one example of the center beam 22 comprises a rectangular tube 30 extending longitudinally between opposite forward and rearward ends 32, 34, respectively. A trailer ball receiver 36 is mounted on the forward end 32 for attaching the trailer 20 to a tow vehicle (not shown). A pair of supplementary wheels 38 is provided on the beam 22 behind the ball receiver 36. As will be appreciated, when the beam 22 is separated from the platform 24, the supplementary wheels 38 allow the user to maneuver the beam from the rearward end 34 while the forward end 32 is supported by the supplementary wheels. A housing 40 containing a conventional brake system is mounted on a side of the beam 22 behind the supplementary wheels 38. A pigtail 42 (partially shown) extends from the housing 40 for operatively connecting the trailer brakes to the tow vehicle. The rearward end 34 of the beam 22 includes a socket (not shown) to receive a trailer brake connector 44 when connecting the beam 22 and platform 24. A petroleum-based polymer (e.g., HDPE) strip 46 is mounted on an upper surface of the beam 22 using spaced screw fasteners 48 to reduce friction between the carrier assembly 26 and the beam 22 when moving the carrier assembly between its rearward position and its forward position.

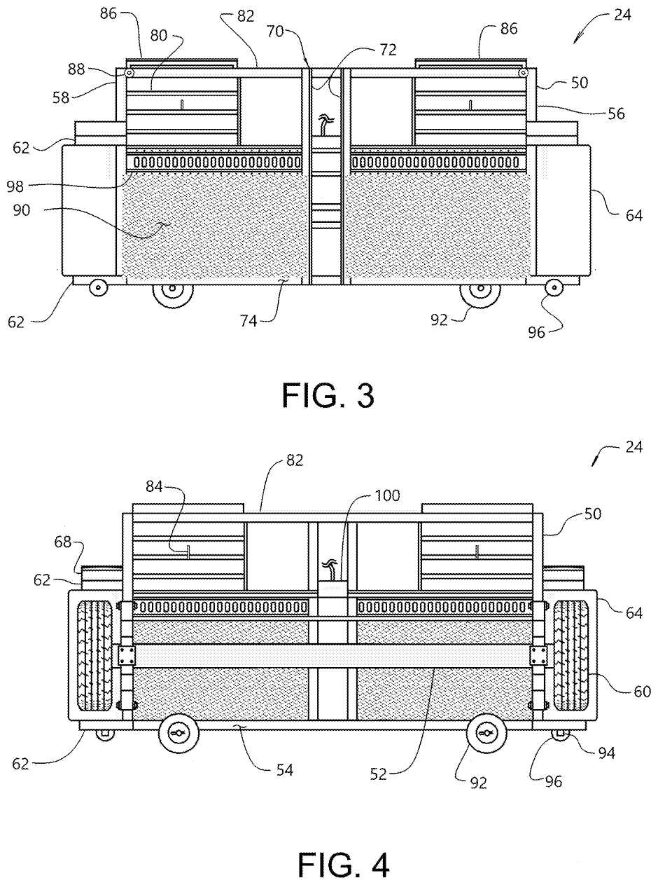

As shown in FIGS. 3 and 4, one example of the platform 24 comprises a frame (generally designated by 50) fashioned from C-channel. A conventional trailer axle (generally designated by 52) extends laterally below a bottom 54 of the frame 50 between a left side 56 and a right side 58 of the frame. Wheels 60 are provided on opposite ends of the axle 52 for supporting the platform 24 and permitting the trailer 20 to move forward and rearward. Brackets 62 extend outward from each side 56, 58 of the frame 50 for mounting conventional trailer fenders 64 above the wheels 60. In addition, plates 66 extend from the sides 56, 58 of the frame 50 behind the fenders 64 to protect conventional trailer lights 68 mounted below the plates. A beam mount (generally designated by 70) formed in the illustrated example by a pair of laterally spaced flanges 72 extending upward from a top 74 of the frame 50. The flanges 72 are spaced for receiving the rearward end 34 the beam 22 as shown in FIG. 1. As will be appreciated, the flanges 72 and beam 22 having openings or holes (not shown) that are aligned when the beam is properly positioned in the mount 70. As further shown in FIG. 1, release pins 76 and keepers 78 are inserted through the aligned openings or holes in the flanges 72 and beam 22 to releasably connect the beam to the platform 24. A vehicle wheel support, generally designated by 80, is provided adjacent to a back 82 of the frame 50 adjacent to the sides 56, 58. Although the supports 80 may have other configurations, in the illustrated example the supports for formed from square tubing and plate stock. A hook 84 is extends downward from each wheel support 80 for receiving the carrier assembly 26 when stored as will be explained. A ramp connector, generally designated by 86, is provided at the back 82 of the frame 50 for connecting a ramp (not shown) to the platform 24 when loading and unloading a vehicle. A bumper 88 is fastened to the bottom 54 of the frame 50 at each rear corner. A deck 90 extends over a front portion of the frame 50 in front of the wheel supports 80. Although the deck 90 may be made of other materials, the deck comprises expanded steel mesh in the illustrated example. A pair of auxiliary wheels 92 are mounted below the front of the trailer frame for moving the platform 24 when separated and upended as shown in FIG. 4. A leg 94 extends upward in front of each fender 64 for supporting the upended platform 24 when tilted toward the legs. In the illustrated example, a wheel 96 is provided at the upper end of each leg 94. Conventional E-track 98 is positioned between the deck 90 and wheel supports 80 for securing the vehicle wheels to the trailer 20. A housing 100 is mounted on the frame 50 below the beam mount 70. The housing includes a cable (partially shown) having the trailer brake connector 44 that is connected the socket on the rearward end 34 of the beam 22 for operatively connecting the trailer brakes on the platform 24 to the pigtail 42 at the forward end 32 of the beam 22.

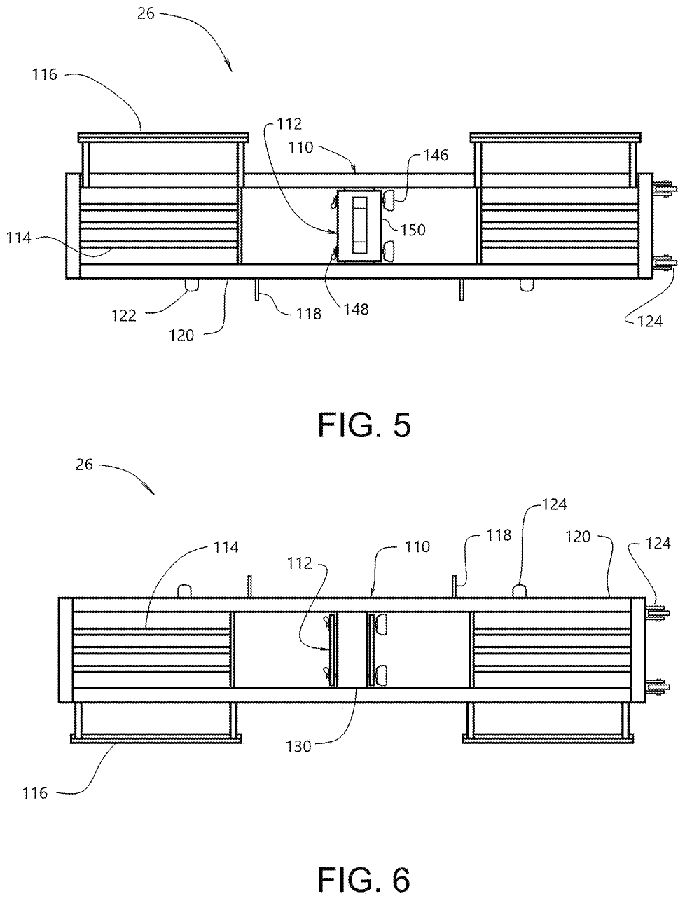

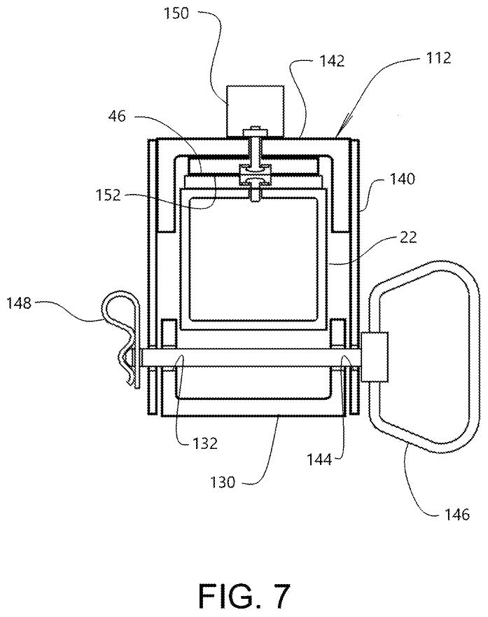

FIGS. 5 and 6 illustrate one example of the carrier assembly 26 comprising a carrier frame (generally designated by 110) and a connector (generally designated by 112) for slidably attaching the carrier assembly 26 to the beam 22. The carrier frame is fashioned from C-channel in the illustrated example and includes a vehicle wheel support or rest 114 adjacent to the sides of the frame 112. A wheel stop 116 extends upward in front of each wheel rest 114 to engage the vehicle wheel when held by the wheel rest. Pins or pegs 118 extend rearward from a rearward surface 120 of the frame 110. The pins 118 engage openings (not shown) in the front of the platform frame 50 when the carriage assembly 26 is in the rearward position as shown in FIG. 1 to support the carriage assembly against rotation about the beam 22. Keepers (not shown) may be inserted through the pins 118 to hold the carriage assembly 26 in the rearward position. A bumper 122 is fastened to the rearward surface 120 of the frame adjacent to each pin 118. Roller assemblies 124 are provided on one side of the frame 110. As will be appreciated, when the carrier assembly 26 separated from the beam 22, the rollers assemblies 124 allow the user to roll the assembly 26. A connector mount 130 fashioned from a C-channel is positioned between the wheel supports 114. As shown in FIG. 7, the connector mount 130 has openings or apertures 132 extending laterally through the mount 130.

As further illustrated in FIG. 7, the connector 112 has opposing walls 140 extending downward from a top member 142. Each wall 140 has a pair of holes 144 which align with the openings 132 in the mount 130 when the connector 112 is properly positioned on the carrier assembly 26. Connector pins 146 and keepers 148 are inserted through the aligned openings or holes in the mount 132 and walls 140 to releasably attach the connector 112 to the carriage assembly 26. A handle 150 extends upward from the top member 142 for lifting the connector 122 when disconnected from the mount 130. A petroleum-based polymer (e.g., HDPE) pad 152 is fastened to a lower surface of the top member 142 to engage the strip 46 on the beam 22 to reduce friction between the connector 112 and the beam as the carriage assembly 26 moves along the beam. As will be appreciated, when the beam 22 is positioned between the connector 112 and mount 130 and the connector pins 146 are inserted through the aligned openings or holes in the mount 130 and walls 140, the beam is captured between the connector and the carriage frame 110 and the carriage assembly 26 is moveable along the beam between the rearward position and the forward position.

The platform 24, carrier assembly 26, and beam 22 may be constructed of suitable materials such as steel or aluminum shapes (e.g., tube, C-channel, angle, and plate). Further, the shapes may be joined using conventional means such as with screw fasteners or by welding. Conventional surface coatings are envisioned, including powder coating, galvanizing, plating, and anodizing.

To assemble the trailer 20, a user positions the beam 22 over the connector mount 130 on the carrier assembly 26 and aligns the openings 132 in the mount 130 with the holes in the connector 112 walls 140. The connector pins 146 are pushed through the aligned openings and holes to connect the connector 112 to the carriage assembly 26. Keepers 148 are attached to the connector pins 146 to retain the pins in position in the holes. The user maneuvers the beam 22 into position in the beam mount 70 on the platform 24 and aligns the corresponding holes and openings in the beam and mount before inserting the release pins 76 through the aligned openings or holes to releasably connect the beam to the platform. Keepers 148 are attached to the release pins 76 to hold the pins in position in the holes. The user inserts the trailer brake connector 44 into the socket on the rearward end 34 of the beam 22 to operatively connect the trailer brakes on the platform 24 to the pigtail 42 at the forward end 32 of the beam. The trailer is connected to the tow vehicle in a conventional manner.

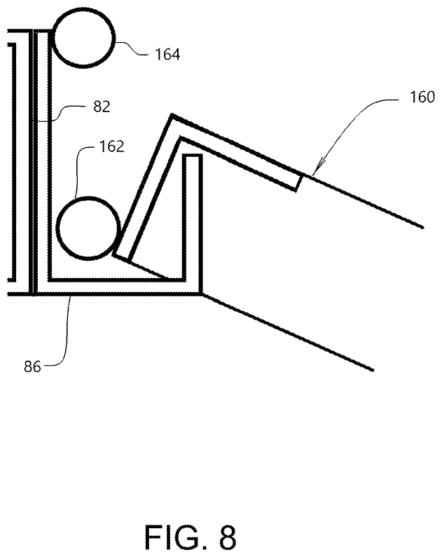

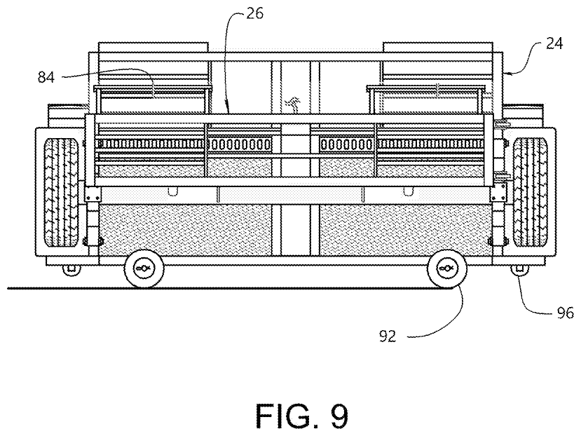

With the trailer 20 connected to the tow vehicle, a vehicle (e.g., an ATV) may be loaded on the trailer. As shown in FIG. 8, ramps, generally designated by 160, are attached to the ramp connectors 86 is provided at the back 82 of the frame 50. In the illustrated example, the ramps are hooked over the ramp connectors 86. Bars 162, 163 provided on the ramps 160 and connectors 86 prevent the ramps from being inadvertently disconnecting from the connectors. With the ramp in position, the user drives the vehicle up the ramps and across the platform 24 until the forward wheels (i.e., the front wheels when the vehicle is driven forward onto the trailer 20) are positioned on the wheel supports 114 of the carriage assembly 26 and against the stops 116. The forward wheels are fastened to the carriage assembly 26 using conventional tie down straps (not shown). The user advances the vehicle farther onto the trailer 20. As the vehicle advances, the carrier assembly 26 slides forward on the beam 22 and away from the platform 24. The user continues to drive the vehicle farther forward on the trailer 20 until the carrier assembly 26 is in the forward position and the rearward wheels are positioned on the wheel supports 80 of the platform 24. Conventional tie down straps may be used to attach the rearward wheels of the vehicle to the platform 24. Once the vehicle is loaded, the ramps are removed and stowed. To unload the vehicle from the trailer 20, the ramps are attached to the ramp connectors 86 and the loading process is reversed.

With the vehicle unloaded, the trailer may be disassembled by reversing the assembly procedures. When the platform 24 and carriage assembly 26 are disconnected and separated from the beam 22, the platform may be upended onto its auxiliary wheels 92 and tilted so the wheels 96 on the legs 94 contact support the platform in the upended orientation. The auxiliary wheels 92 and legs 94 allow the platform to be stored upended in a smaller floor space. The carriage assembly 26 is rolled to the stored platform 24 and lifted onto the hooks 86 on the platform to store the carriage in the same area occupied by the platform. The beam 22 may be wheeled to suitable location for storage.

In view of the above, it will be seen that at least some objects are achieved, and other advantageous results attained by the examples described above.

Although the specification includes examples, the scope is not intended to be limited to the particular illustrated and described examples. Furthermore, although the specification has been described in language specific to structural features and/or methodological acts, the scope is not intended to be limited to the features or acts described. Rather, the specific features and acts are disclosed as examples of the disclosure.

When introducing elements in this description, the articles “a”, “an”, “the”, and “said” are intended to mean that there are one or more of the elements. The terms “comprising”, “including”, and “having” are intended to be inclusive and mean that there may be additional elements other than the listed elements.

As those skilled in the art could make various changes to the above constructions, products, and methods without departing from the intended scope of the description, all matter in the above description and accompanying drawings should be interpreted as illustrative and not in a limiting sense.

What is claimed is:

1. A trailer for transporting a vehicle having a forward wheel and a rearward wheel, said trailer comprising:
a longitudinal beam extending between a forward end from which the trailer is towed and a rearward end opposite the forward end;
a platform having a left side, a right side opposite the left side, a back extending between the left side and the right side, a front opposite the back, a top extending between the back and the front and a bottom opposite the top, the top having a support for receiving the rearward wheel of the vehicle, said platform having a mount for releasably attaching the beam to the platform so the forward end of the beam extends forward from the front of the platform, said platform having an axle extending laterally below the bottom of the platform between a left wheel and a right wheel for supporting the platform and permitting the trailer to move forward and rearward;
a carriage assembly including frame having a top surface and a bottom surface opposite said top surface, the top surface including a rest for supporting the forward wheel of the vehicle, said carriage assembly including a connector for selectively connecting the carriage assembly to the beam in front of the platform so the carriage assembly is moveable along the beam between a rearward position in which the carriage assembly is adjacent to the platform and a forward position in which the carriage assembly is spaced from the platform.

2. A trailer as set forth in claim 1, further comprising:
a release pin for releasably connecting the beam to the platform;
wherein the beam includes a hole therethrough adapted for selectively receiving the release pin; and
wherein the mount comprises a pair for opposing flanges adapted to selectively receive the beam therebetween, each flange of said pair for opposing flanges having an opening positioned to align with the hole through the beam to receive the release pin when the beam is positioned between the pair of opposing flanges to releasably attach the beam to the platform.

3. A trailer as set forth in claim 2, wherein the pair of opposing flanges extend upward between the front and the back of the platform for receiving the beam from above the platform.

4. A trailer as set forth in claim 1, further comprising:
a connector pin for releasably connecting the connector to the frame;
wherein the connector has a pair of opposing walls defining a space sized for receiving the beam therein, each wall of said pair of opposing walls having a hole positioned for receiving the connector pin;
wherein the frame has an aperture adapted for receiving the connector pin when the connector pin is simultaneously received by the hole in each wall of said pair of opposing walls to releasably connect the connector to the frame; and
wherein when the beam is positioned in the space defined by the pair of opposing walls and the connector pin extends through the hole in each wall of said pair of opposing walls of the connector and the aperture in the frame, the beam is captured between the connector and the frame, and the carriage assembly is moveable along the beam between the rearward position and the forward position.

5. A trailer as set forth in claim 4, wherein when the beam is positioned in the space defined by the pair of opposing walls and the connector pin extends through the hole in each wall of said pair of opposing walls of the connector and the aperture in the frame, the connector is positioned above the frame and the beam is positioned between the connector and the frame.

6. A trailer as set forth in claim 5, wherein:
a petroleum-based polymer strip is mounted on an upper surface of the beam; and
the connector has a petroleum-based polymer pad positioned to engage the petroleum-based polymer strip mounted on the beam to reduce friction between the connector and the beam as the carriage assembly moves along the beam.

7. A trailer as set forth in claim 1, further comprising an auxiliary wheel mounted on the platform adjacent to at least one of the back and the front for moving the platform parallel to the axle when the platform is oriented so the platform is supported by the auxiliary wheel.

8. A trailer as set forth in claim 7, further comprising a leg extending from the platform to maintain the platform in an orientation in which the platform is supported by the auxiliary wheel.

9. A trailer as set forth in claim 8, wherein leg includes a wheel opposite the platform.

10. A trailer as set forth in claim 7, wherein the platform includes a hook for hanging the carriage assembly on the platform when the platform and carriage assembly are disconnected from the beam and the platform is oriented so the platform is supported by the auxiliary wheel.

11. A trailer as set forth in claim 1, further comprising a roller mounted on the frame of the carriage assembly for moving the carriage assembly when the carriage assembly is oriented so the carriage is supported by the roller.

12. A trailer as set forth in claim 1, further comprising a supplementary wheel mounted on the beam for moving the beam longitudinally when the beam is oriented so the beam is supported by the supplementary wheel.

13. A trailer as set forth in claim 1, wherein:
at least one of a front of the platform and a rearward surface of the frame of the carriage assembly has a peg extending toward the other of the front of the platform and the rearward surface of the frame; and
the other of the front of the platform and the rearward surface of the frame has an opening positioned for receiving the peg when the carriage assembly is in the rearward position to support the carriage assembly against rotation about the beam.

14. A method of assembling a trailer for transporting a vehicle having a forward wheel and a rearward wheel, said method comprising the steps of:
positioning a longitudinal beam having a forward end and a rearward end opposite the forward end atop a carriage frame;
connecting the positioned carriage frame to the beam so the frame is selectively moveable longitudinally along the beam;
setting the rearward end of the beam on a mount on a platform having a left wheel and a right wheel for selectively moving the trailer forward and rearward; and
pinning the rearward end of the beam to the mount.

15. A method as set forth in claim 14, further comprising the steps of:
sliding the carriage frame rearward on the beam so the carriage frame is adjacent to the platform;
driving the vehicle onto the platform so the forward wheel of the vehicle is supported by the platform;
advancing the vehicle so the forward wheel of the vehicle rests on the carriage frame;
attaching the forward wheel of the vehicle resting on the carriage frame to the carriage frame; and
moving the vehicle forward so the rearward wheel of the vehicle is supported by the platform thereby moving the carriage frame forward along the beam to a forward position.

16. A method of disassembling a trailer for storage, comprising the steps of disconnecting a connector pin from a connector connected to a carriage frame thereby allowing the connector to be separated from the carriage frame;
removing the connector from the carriage frame thereby allowing the beam to be separated from the carriage frame;
separating the beam from the carriage frame;
pulling a release pin from a platform attached to the beam thereby releasing the beam from the platform; and
separating the released beam from the platform.

17. A method as set forth in claim 16, further comprising the steps of:
upending the platform onto an auxiliary wheel mounted on the platform so the platform is supported by the auxiliary wheel; and
hanging the carriage frame on the upended platform.

18. A method as set forth in claim 17, further comprising the step of tilting the upended platform so the platform is supported by a leg and the auxiliary wheel.
